(19) United States
(12) Patent Application Publication
(10) Pub. No.: US 2006/0117361 A1
(43) Pub. Date: Jun. 1, 2006

(54) Data communications system using CATV network with wireless return path

(76) Inventor: Alex Dolgonos, Thornhill (CA)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/266,853

(22) Filed: Nov. 4, 2005

Related U.S. Application Data
(60) Provisional application No. 60/625,098, filed on Nov. 5, 2004.

(51) Int. Cl. H04N 7/173

(52) U.S. Cl. 725/105; 725/127; 725/117

(57) ABSTRACT

A communications network for providing two-way data transfer, including a distribution hub, a plurality of subscriber locations for receiving downstream data signals from and transmitting upstream data signals to the distribution hub, a wired network connecting the distribution hubs to the plurality of subscriber networks, at least a portion of the wired network including a coaxial cable television plant, at least a portion of the coaxial cable television plant between the distribution hub and an intermediate location being enabled for transmitting downstream data signals, and a terminal portion of the cable television plant extending from the intermediate location to the plurality of subscriber locations being enabled for transmitting upstream and downstream data signals. A wireless transmitter at the intermediate location is provided for receiving, over the terminal portion, upstream signals from the plurality of subscriber locations, and transmitting the upstream signals modulated as wireless communications signals. A wireless receiver is provided for receiving and demodulating the wireless communications signals to produce the upstream signals at the distribution hub.

### RELATED APPLICATIONS

This application claims priority to U.S. Provisional Patent Application Ser. No. 60/625,098 filed Nov. 5, 2004.

### BACKGROUND OF THE INVENTION

The present invention relates to data communications in which the communications path includes a wired downstream portion in the form of a cable TV plant and an over-the-air wireless upstream portion.

The use of cable or community access television (CATV) infrastructure to provide a two way network for data communications continues to grow in popularity. In the United States, CableLabs® administers the CableLabs Certified™ Cable Modems project, formerly known as DOCSIS™ (Data Over Cable Service Interface Specification), that defines interface requirements for cable modems involved in high-speed data distribution over cable television system networks. Many cable companies have adopted the DOCSIS standards to provide Internet services over existing cable plants. However, many cable companies have legacy cable networks that include older active components, such as line extenders, that only permit downstream data and do not provide for the upstream path required for two way data transfer. Often, it is not economically feasible to upgrade the active components in existing one-way cable plants to handle two-way traffic.

Thus, there is a need for a cost effective system and method for providing wireless high speed Internet and video services by using existing cable TV network infrastructure as part of the communications path.

### BRIEF SUMMARY OF THE INVENTION

According to one aspect of the invention, there is provided a method for providing two way data signals between a distribution hub and a plurality of subscriber locations wherein a wired network is provided between the hub and the subscriber locations, at least a portion of the wired network intermediate the distribution hub and an intermediate location prior to the subscriber locations being enabled for downstream signals, and a terminal portion of the wired network extending from the intermediate location to the subscriber locations being enabled for both upstream and downstream signals. The method includes (a) transmitting downstream signals from the distribution hub over the wired network to the plurality of subscriber locations; (b) transmitting upstream signals from a plurality of subscriber locations over the terminal portion of the wired network to the intermediate location and then transmitting the upstream signals from the intermediate location as over the air radio signals to the distribution hub.

The intermediate location is preferably after a final active component in the wired network prior to and remote from the subscriber locations.

According to another aspect of the invention, there is provided a communications network for providing two-way data transfer, including a distribution hub, a plurality of subscriber locations for receiving downstream data signals from and transmitting upstream data signals to the distribution hub, a wired network connecting the distribution hubs to the plurality of subscriber networks, at least a portion of the wired network including a coaxial cable television plant, at least a portion of the coaxial cable television plant between the distribution hub and an intermediate location being enabled for transmitting downstream data signals, and a terminal portion of the cable television plant extending from the intermediate location to the plurality of subscriber locations being enabled for transmitting upstream and downstream data signals. A wireless transmitter at the intermediate location is provided for receiving, over the terminal portion, upstream signals from the plurality of subscriber locations, and transmitting the upstream signals modulated as wireless communications signals. A wireless receiver is provided for receiving and demodulating the wireless communications signals to produce the upstream signals at the distribution hub.

### BRIEF DESCRIPTION OF THE DRAWINGS

FIG. 1 is a block diagram of a hybrid cable/wireless communications system according to embodiments of the present invention.

FIG. 2 is a block diagram of the regional cable headend of the communications system.

FIG. 3 is a block diagram of the distribution hub of the communications system.

### DETAILED DESCRIPTION OF THE INVENTION

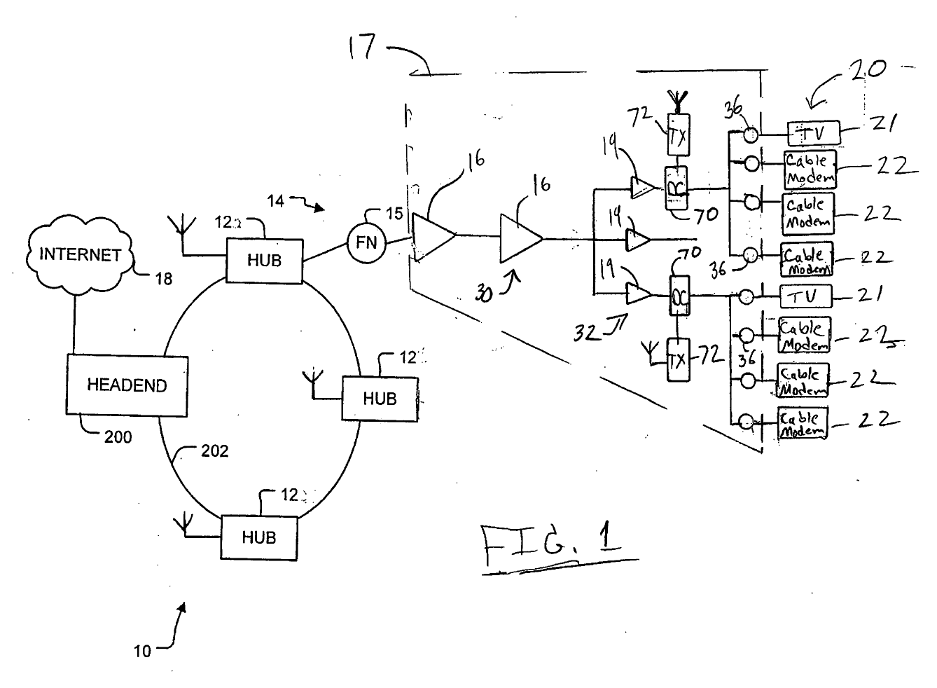

FIG. 1 shows a hybrid cable/wireless communications system 10 in accordance with certain embodiments of the present invention. The communications system 10 combines wireless transmitters and receivers with existing one-way cable infrastructure to provide video distribution and Internet services in which a portion of the return or upstream path is wireless. In the illustrated embodiment the communications system 10 includes a conventional cable TV hierarchal redundant ring structure in which a regional cable headend 200 is connected by a fibre ring 202 to a number of distribution hubs 12, which in turn are each connected by respective hybrid fibre/coaxial cable plants 14 (only one of which is shown in FIG. 1) to subscriber locations 20 at which are located television receivers 21 and/or cable modems 22. According to the present invention, the headend 200, fibre ring 202, distribution hubs 12 and cable plant 14 provide a communications link through which Internet ready devices, such as personal computers, located at subscriber locations 20 can communicate with the Internet 18. As will be explained in greater detail below, the communications system 10 allows transparent bi-directional transfer of Internet Protocol (IP) traffic, between the headend 200 and the subscriber locations 20, over a wired downstream communications path and a combined wired/wireless upstream communications path.

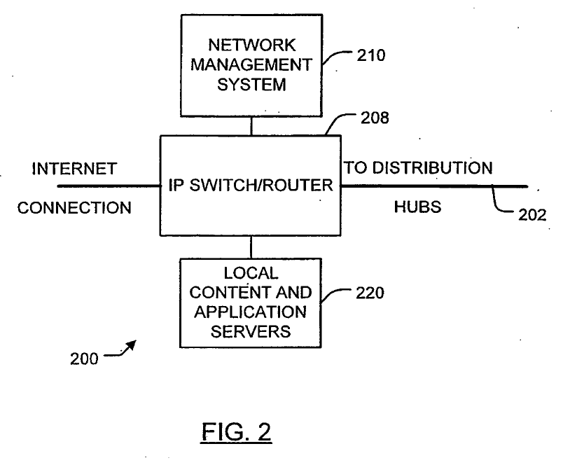

The regional cable headend 200 serves as a local data network operations centre and is the gateway between the communications system 10 and the Internet 18. With reference to FIG. 2, the headend 200 includes a carrier-class IP switch or router 208 that interfaces with a backbone data network offering connectivity to the global Internet 18. The router 208 is connected to the distribution hubs 12 by fibre ring 202. The headend 200 also includes a network management system 210 which comprises the hardware and software necessary to run a cable data network, including for example servers for file transfer, user authorization and accounting, log control, IP address assignment and administration (Dynamic Host Configuration Protocol—DHCP), Domain Name Servers (DNS), and data over cable protocol (for example, DOCSIS) control. Additionally, the headend 200 may include local content and application servers 220, including for example e-mail, Web hosting, news, chat, proxy, caching, and streaming media servers. The headend 200 will also generally include conventional television network headend equipment (not shown).

The headend network management system 210 may use Simple Network Management Protocol (SNMP, or other suitable protocols, for managing the communications system 10. The network management system 210 maintains a list of all the addresses of the IP devices that make up and are served by the communications system 10, including information as to which subscriber IP devices are serviced by each hub 12. As in known data over cable networks, such address information is used by the IP router 208 to direct downstream data to the appropriate hub 12 so that the downstream data can then be routed to the appropriate subscriber address. Network management protocols for data over cable are well known in the art. Conveniently, communications between the router 208 and the distribution hubs may be carried out using high-capacity packet transport solutions, such as Packet Over SONET (POS).

With reference to FIG. 1, in the illustrated embodiment of the invention, the cable plant 14 that is associated with each hub 12 includes an existing hybrid fibre coaxial (HFC) cable plant infrastructure that is capable of supporting down stream traffic from the hub 12 to subscriber locations 36. In the illustrated embodiment, the cable plant 14 includes a fibre termination node 15, and a coaxial cable plant 17. The fibre node 15 is connected by a fibre link to the distribution hub 12, and converts optical signals received from the hub 12 over the fibre link into RF signals for transmission over the coaxial plant 17. Although only one fibre node 15 per cable plant 14 is illustrated in FIG. 1, each cable plant 14 will generally include a plurality of fibre nodes 15, each having a coaxial cable plant 17 extending therefrom. In some embodiments, the distribution hub may be connected directly to the coaxial cable plant 17, without any intermediate fibre plant. Additionally, some or all of the equipment and functionality of headend 200 could be located at one or more of the hubs 12.

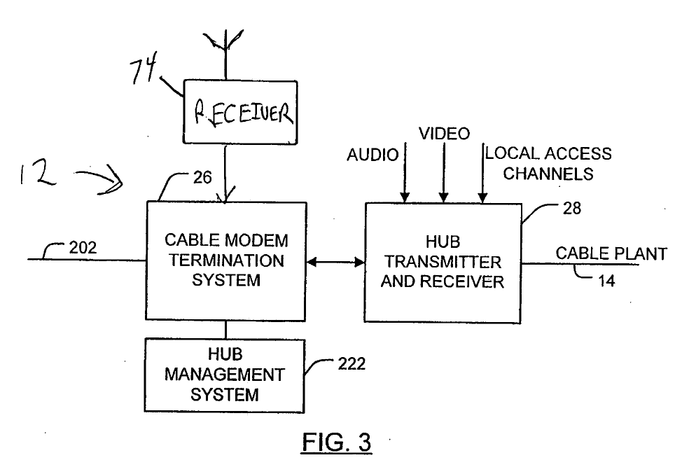

In the illustrated embodiment, the coaxial cable plant 17 is a legacy system that supports wired communications in only a downstream direction. It includes a backbone or trunk line 30 that includes active components such as distribution or main amplifiers 16 that provide the requisite gain to downstream signals. The downstream signals are provided to numerous distribution lines 32 that branch off from the trunk line. The branch distribution lines 32 generally include one or more one-way active components such as line extender/bridging amplifiers 19. Passive taps 36 located downstream of amplifiers 19 throughout the coaxial cable plant 17 connect subscriber locations 20 (and in particular televisions 21 and cable modems 22 at the subscriber locations) to receive downstream signals from the cable plant. Generally, several subscriber locations 20 may be serviced by a single line extender amplifier 19 that is remotely located from the subscriber locations. Although amplifiers 19 prevent upstream signals from passing therethrough, in an example embodiment, there are no one-way active components located between the amplifier 19 and its associated subscriber taps 36 to prevent upstream signals from flowing from the subscriber locations to a location at the output of the amplifier 19. According to example embodiments the present invention, a directional coupler 70 is located just downstream of the amplifier 19 to route upstream signals from cable modems 22 to a wireless transmitter 72. Hub 12 includes a wireless receiver 74 (FIG. 3) for receiving the upstream signals transmitted from transmitter 72.

Each cable modem 22 may be a conventional two-way enabled data-over-cable modem that uses standard protocols to demodulate downstream signals that arrive at a subscriber location over the cable plant into a format suitable for application to a personal computer system or other computing device. Similarly, the cable modem 22 uses standard protocols to modulate signals from one or more computer devices at the subscriber location onto upstream signals that are applied to the coaxial cable at the subscriber location. The upstream signals from all the cable modems 22 that are connected to a common final active component on the coaxial plant 17 (in the illustrated case, an amplifier 19) are picked up off of the cable plant at the directional coupler 70, and modulated at transmitter 72 for over-the-air transmission to hub 12.

Each transmitter 72 thus receives, over a corresponding terminal portion of the coaxial cable plant 17, upstream signals from a plurality of subscriber locations. The subscriber locations share the upstream channel resources according to conventional data-over-cable protocol. At the transmitter 72, the upstream signals are modulated for radio transmission. In one embodiment, transmitter 72 may be an OFDM (Orthogonal Frequency Division Multiplexing) transmitter. OFDM modulation is an attractive form of modulation due to its high spectral efficiency and resistance to noise and multipath effects. The wireless transmissions sent by the transmitter 72 could be in the MMDS bands (Multichannel Multipoint Distribution Service, ie. 2.1-2.7 GHz microwave band). It will be appreciated that other forms and variations of multi-carrier modulations could be used for the wireless link of the present invention, and in some circumstances single carrier modulation schemes could be used. Other radio frequency ranges could also be used.

In an example embodiment, each transmitter 72 and directional coupler 19 is located at the same location (for example, on the same pole or at the same connection box) as the final one-way active component (amplifier 19) that provides downstream signals to the subscriber locations that are serviced by the transmitter 72. The same power source that is used for the amplifier 19 is preferably also used to power the directional coupler 19 and transmitter 72. In some embodiments, this power for the coupler 19 and transmitter 72 may be supplied on the coaxial cable of the cable plant itself.

FIG. 3 shows the configuration of a distribution hub 12 according to an embodiment of the invention. The distribution hub 12 includes a Cable Modem Termination System (“CMTS”) 26 that complies with a standard data-over-cable protocol (for example, DOCSIS), a hub management system 222, a conventional cable hub transmitter and receiver 28, and a wireless receiver 74. The CMTS 26 is essentially a data switching system designed to, on the downstream side, receive data from the Internet, via the headend 200, and provide the data switching necessary to route data over a downstream data channel to a group of subscribers in the service area served by the hub 12. In one embodiment, the CMTS 26 includes a 64/256 QAM modulator for modulating user data for a group of subscribers onto a 6 MHz downstream data channel (which is the bandwidth allocated to a conventional North American CATV channel). Under DOCSIS, each 6 MHz downstream channel can accommodate a finite number of subscribers (for example, 500-1000) with an acceptable QoS. In the event that the hub 12 serves more subscribers than can be satisfactorily served with a single 6 MHz downstream channel, the hub 12 can include additional CMTS 26 units to support additional downstream and upstream data channels. On the upstream side, CMTS 26 takes the traffic coming in from a group of customer IP devices and routes it through the headend 200 to an Internet Service Provider (ISP) for connection to the Internet 18. The upstream signals come from wireless receiver 74, which is configured to demodulate RF signals received from one or more transmitters 72 that are associated with the cable plant 17. Typically, the receiver 74 will receive signals from a plurality of transmitters 72, each of which is associated with a plurality of subscriber locations. The RF upstream signals received by the receiver 74 are converted into upstream signals that conform to conventional data-over-cable protocols such that they can be applied to a substantially conventional CMTS. The CMTS includes a QPSK/16 QAM demodulator for demodulating user data from the upstream data channel.

The cable hub transmitter and receiver 28 combines the downstream signal on the data channel output from the CMTS 26 with video, audio, pay-per-view, and local programs that are received by television subscribers. The combined signal is transmitted by the hub transmitter and receiver 28 throughout the cable plant 14. The hub management system 222 includes servers configured to support the operations of hub 12 in providing Internet access to the subscriber locations 20. In this respect, the hub management system 222 stores information identifying the addresses of the IP devices that it services at any particular time.

The present invention has been described largely in the context of the DOCSIS 1.1 North American technology option, however it is not limited only to systems using such protocol. For example, another possible cable modem protocol is the DVB/DAVIC EuroModem protocol, and communications between the distribution hubs 12a-c and their associated antenna nodes 16 could alternatively be based on such protocol, or on European DOCSIS.

In example embodiments of the invention, the use of a wireless upstream link to by-pass one-way sections of the cable plant is substantially invisible to the cable modems 22 located at subscriber locations 20, and the CMTS at the hub, such that conventional cable modems and CMTS equipment can be used in the present system with little modification. Embodiments of the present invention allow the upstream signals from a plurality of subscriber locations to be handled by a single transmitter. The subscriber locations 20 may be at different family homes, or offices, that are spread out over a geographic area, with the transmitter 72 being remotely located from the subscriber locations that it services.

While the invention has been described in terms of various specific embodiments, those skilled in the art will recognize that the invention can be practiced with modification within the spirit and scope of the claims.

What is claimed is:

1. A method for providing two way data signals between a distribution hub and a plurality of subscriber locations wherein a wired network is provided between the hub and the subscriber locations, at least a portion of the wired network intermediate the distribution hub and an intermediate location prior to the subscriber locations being enabled for downstream signals, and a terminal portion of the wired network extending from the intermediate location to the subscriber locations being enabled for both upstream and downstream signals, comprising:
transmitting downstream signals from the distribution hub over the wired network to the plurality of subscriber locations;
transmitting upstream signals from a plurality of subscriber locations over the terminal portion of the wired network to the intermediate location and then transmitting the upstream signals from the intermediate location as over the air radio signals to the distribution hub.

2. The method of claim 1 wherein the intermediate location is after a final active component in the wired network prior to and remote from the subscriber locations.

3. The method of claim 2 including providing power from a common power source located at the intermediate location to both the final active component and a transmitter that is located at the intermediate location for transmitting the upstream signals from the intermediate location.

4. The method of claim 1 wherein the intermediate location is located substantially at the output of a final amplifier in the wired network prior the subscriber locations.

5. The method of claim 4 wherein a transmitter is located at the intermediate location for transmitting the upstream signals from the intermediate location, the method including providing power to the transmitter from the wired network.

6. The method of claim 1 wherein the terminal portion of the wired network includes coaxial cable links to the plurality of subscriber locations over which the downstream and upstream signals are transmitted.

7. The method of claim 1 including receiving the upstream signals at the distribution hub and routing the upstream signals over a fibre link to a headend at which an Internet connection is located.

8. The method of claim 1 wherein the downstream signals include signals received from the Internet and upstream signals include signals destined for the Internet.

9. The method of claim 1 wherein the over the air radio signals are OFDM signals.

10. The method of claim 1 wherein the over the air radio signals are broadcast within the 2.1-2.7 GHz range.

11. A communications network for providing two-way data transfer, comprising:
a distribution hub;
a plurality of subscriber locations for receiving downstream data signals from and transmitting upstream data signals to the distribution hub;
a wired network connecting the distribution hubs to the plurality of subscriber networks, at least a portion of the wired network including a coaxial cable television plant, at least a portion of the coaxial cable television plant between the distribution hub and an intermediate location being enabled for transmitting downstream data signals, and a terminal portion of the cable television plant extending from the intermediate location to the plurality of subscriber locations being enabled for transmitting upstream and downstream data signals;
a wireless transmitter connected to the intermediate location for receiving, over the terminal portion, upstream signals from the plurality of subscriber locations, and transmitting the upstream signals modulated as wireless communications signals; and
a wireless receiver for receiving and demodulating the wireless communications signals to produce the upstream signals at the distribution hub.

12. The network of claim 11 wherein the coaxial cable television plant includes plurality of unidirectional active components leading downstream from the distribution hub, and wherein the intermediate location is located after a final one of the unidirectional active components in the coaxial cable television plant prior to and remote from the subscriber locations.

13. The network of claim 12 including a power source located at the intermediate location providing power to both the final unidirectional active component and the transmitter.

14. The network of claim 12 wherein the final unidirectional active component includes an amplifier and the transmitter is located substantially at the output of the amplifier.

15. The network of claim 11 including a directional coupler in the cable television plant at the intermediate location for directing the upstream signals to the transmitter.

16. The network of claim 11 wherein the downstream signals include signals received from the Internet and upstream signals include signals destined for the Internet.

17. The network of claim 11 wherein the transmitter transmits the wireless communications signals as OFDM signals.

18. The network of claim 11 wherein the over the air radio signals are broadcast within the 2.1-2.7 GHz range.
